(19) United States
(12) Patent Application Publication
(10) Pub. No.: US 2004/0090378 A1
(43) Pub. Date: May 13, 2004

(54) Multi-band antenna structure

(76) Inventors: Hsin Kuo Dai, Tu-chen (TW); Hsiang-Hui Shen, Tu-chen (TW); Kun Te Cheng, Tu-chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/330,606

(22) Filed: Dec. 26, 2002

(30) Foreign Application Priority Data
Nov. 8, 2002 (TW) 91217911

(51) Int. Cl. H01Q 1/24

(52) U.S. Cl. 343/700 MS; 343/702

(57) ABSTRACT

A multi-band antenna structure (1) includes a ground plane (10) and a plurality of radiating elements (11, 12, 13, 14, 15). Each radiating element has a radiating portion and a connecting portion connected with the corresponding radiating portion. The first and second connecting portions (111, 121) are respectively connected to the ground plane, and a first resonance slot (21) is formed between the first and second radiating portions (110, 120). The third, fourth, and fifth connecting portions (131, 141, 151) are respectively connected to the second radiating portion. A second resonance slot (22) is formed between the third and fourth radiating portion (130, 140), and a third resonance slot (23) is formed between the third and fifth radiating portion (130, 150).

### BACKGROUND OF THE INVENTION

1. Field of the Invention

The present invention relates to a multi-band antenna structure, and more particularly to a multi-band antenna structure for use in a hand-held telecommunications device, such as a portable computer.

2. Description of Related Art

Patch antennas are widely used in telecommunications devices, such as mobile phones and portable computers, to transmit and receive RF (Radio Frequency) signals. In order to make such telecommunications devices operate in different frequency bands, multi-band antennas are needed for mounting thereon.

U.S. Pat. No. 6,476,769, issued on Nov. 5, 2002 and assigned to Nokia Corporation, discloses a prior art multi-band antenna structure for use in a mobile phone. The prior art multi-band antenna structure includes a ground plane and a plurality of radiating elements. The ground plane and the plurality of radiating elements are separately manufactured, and then are assembled together in the mobile phone. Several actions are needed for the assembly of the multi-band antenna structure, which consumes more time. Therefore, a multi-band antenna structure which is more easily assembled in a hand-held telecommunications device is needed.

### SUMMARY OF THE INVENTION

It is an object of the present invention to provide a multi-band antenna structure which is easy to assemble in a hand-held telecommunications device.

In order to achieve the object set forth, a multi-band antenna structure according to the present invention includes a ground plane and a plurality of radiating elements. The radiating elements include a first to fifth radiating elements. The first radiating element has a first radiating portion disposed beside the ground plane, and a first connecting portion connecting the first radiating portion with the ground plane. The second radiating element has a second radiating portion disposed beside the first radiating portion, and a second connecting portion connecting the second radiating portion with the ground plane. The second radiating portion further includes a feed-point for attaching a feeder cable to, located adjacent to the second connecting portion. The third radiating element has a third radiating portion disposed above the second radiating portion, and a third connecting portion connecting the third radiating portion with the second radiating portion. The fourth radiating element has a fourth radiating portion disposed beside the third radiating portion, and a fourth connecting portion connecting the fourth radiating portion with the second radiating portion. The fifth radiating element has a fifth radiating portion disposed above the third radiating portion, and a fifth connecting portion connecting the fifth radiating portion with the second radiating portion. A first resonance slot is formed between the first and second radiating portions. A second resonance slot is formed between the third and fourth radiating portions. A third resonance slot is formed between the third and fifth radiating portions.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a multi-band antenna structure in accordance with the present invention.

FIG. 2 is a computer simulated return loss chart of the multi-band antenna structure shown in FIG. 1.

### DETAILED DESCRIPTION OF THE INVENTION

Reference will now be made in detail to the preferred embodiment of the present invention.

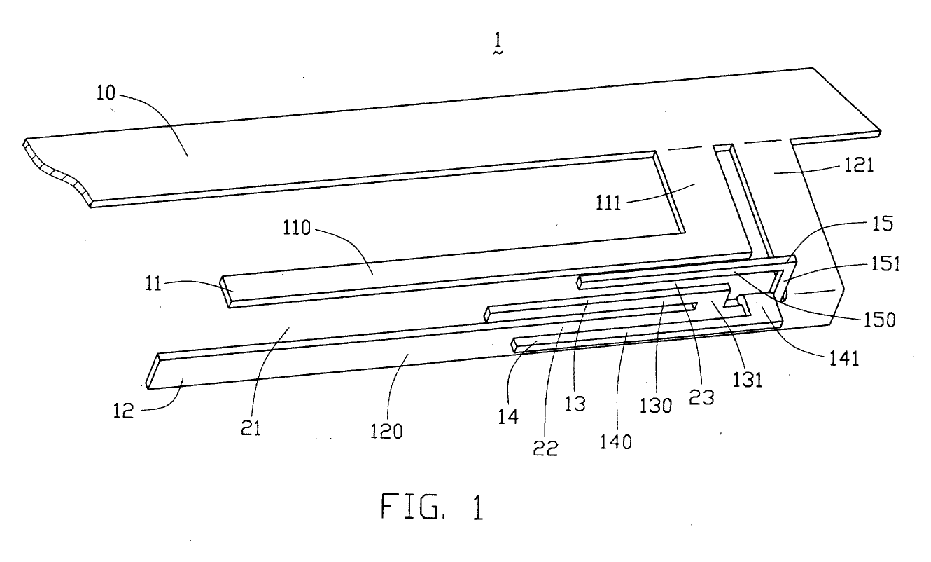

Referring to FIG. 1, a multi-band antenna structure 1 in accordance with the present invention includes a ground plane 10 for grounding, and a plurality of radiating elements, for transmitting and receiving RF signals. The radiating elements includes a first radiating element 11, a second radiating element 12, a third radiating element 13, a fourth radiating element 14, and a fifth radiating element 15. The ground plane 10 is substantially elongated and rectangular

The first radiating element 11 is an L-shaped structure, and includes a first radiating portion 110 and a first connecting portion 111. The first radiating portion 110 is disposed beside the ground plane 10, and has a longitudinal axis parallel to a longitudinal axis of the ground plane 10. The first radiating portion 110 is substantially elongated and rectangular, and is much longer than the first connecting portion 111. An end of the first connecting portion 111 is connected to the first radiating portion 110, and another end of the first connecting portion 111 is connected to the ground plane 10.

The second radiating element 12 is an L-shaped structure, and includes a second radiating portion 120 and a second connecting portion 121. The second radiating portion 120 is disposed beside the first radiating portion 110, and has a longitudinal axis parallel to that of the first radiating portion 110. The second radiating portion 120 is substantially elongated and rectangular, and is much longer than the second connecting portion 121. An end of the second connecting portion 121 is connected to the second radiating portion 120, and another end of the second connecting portion 121 is connected to the ground plane 10. The first connecting portion 111 and the second connecting portion 121 are both located at a first side (not labeled) of the ground plane 10 and are adjacent to each other. A first resonance slot 21 is formed between the first radiating portion 110 and the second radiating portion 120, and a first length of the first resonance slot 21 corresponds to a wavelength ratio of a first resonance frequency. A feed-point (not shown) for connecting a signal feed cable (not shown) is located on the second radiating portion 120, adjacent to the second connecting portion 121.

The third radiating element 13 is an L-shaped structure, and includes a third radiating portion 130 and a third connecting portion 131. The third radiating portion 130 is disposed above the second radiating portion 120, and has a longitudinal axis parallel to that of the second radiating portion 120. The third radiating portion 130 is substantially elongated and rectangular, and is much longer than the third connecting portion 131. An end of the third connecting portion 131 is connected to the third radiating portion 130, and another end of the third connecting portion 131 is connected to the second radiating portion 120. The third connecting portion 131 is located at a second side (not labeled) of the second radiating portion 120, and adjacent to the feed-point on the second radiating portion 120.

The fourth radiating element 14 is an L-shaped structure, and includes a fourth radiating portion 140 and a fourth connecting portion 141. The fourth radiating portion 140 is disposed beside the third radiating portion 130, and has a longitudinal axis parallel to that of the third radiating portion 130. The fourth radiating portion 140 is substantially elongated and rectangular, and is much longer than the fourth connecting portion 141. An end of the fourth connecting portion 141 is connected to the fourth radiating portion 140, and another end of the fourth connecting portion 141 is connected to the second radiating portion 120. The fourth connecting portion 141 is located at the second side of the second radiating portion 120, and adjacent to the feed-point. A second resonance slot 22 is formed between the third radiating portion 130 and the fourth radiating portion 140, and a second length of the second resonance slot 22 corresponds to a wavelength ratio of a second resonance frequency.

The fifth radiating element 15 is an L-shaped structure, and includes a fifth radiating portion 150 and a fifth connecting portion 151. The fifth radiating portion 150 is disposed above the third radiating portion 130, and has a longitudinal axis parallel to that of the third radiating portion 130. The fifth radiating portion 150 is substantially elongated and rectangular, and is much longer than the fifth connecting portion 151. An end of the fifth connecting portion 151 is connected to the fifth radiating portion 150, and another end of the fifth connecting portion 151 is connected to the second radiating portion 120. The fifth connecting portion 151 is located at the second side of the second radiating portion 120, and adjacent to the feed-point. A third resonance slot 23 is formed between the third radiating portion 130 and the fifth radiating portion 150, and a third length of the third resonance slot 23 corresponds to a wavelength ratio of a third resonance frequency.

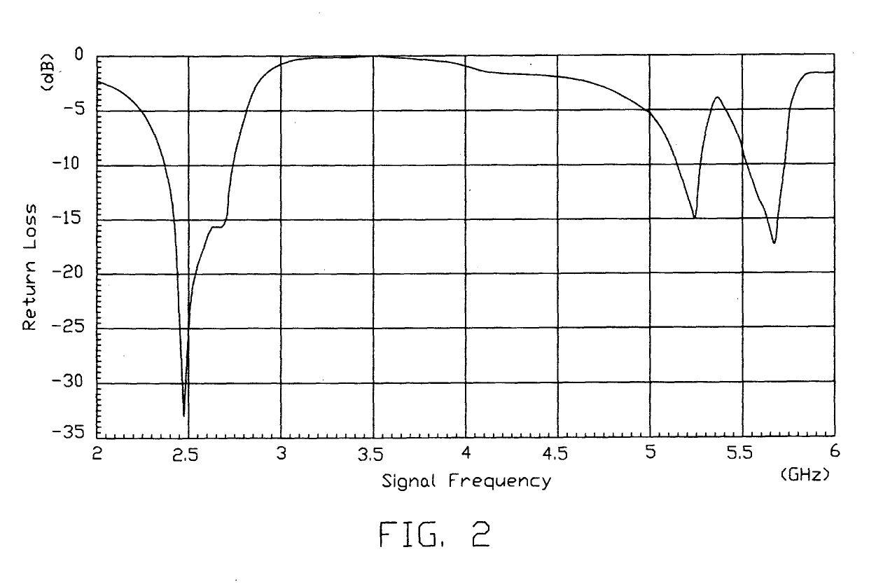

FIG. 2 shows a computer simulated return loss chart for the multi-band antenna structure 1. A value of the return loss below the threshold value “−10 dB” indicates acceptably efficient operation. In FIG. 2, values of return loss are below −10 dB for three frequency bands. The typical frequencies of the three frequency bands are respectively 2.45 GHz, 5.25 GHz, and 5.7 GHz, as shown is FIG. 2. The first length of the first resonance slot 21 corresponds to a wavelength ratio of 2.45 GHz. The second length of the second resonance slot 22 corresponds to a wavelength ratio of 5.25 GHz. The third length of the third resonance slot 23 corresponds to a wavelength ratio of 5.7 GHz. For example, the wavelength ratio mentioned above is a quarter wavelength. In the preferred embodiment, the multi-band antenna structure 1 can be mounted in a telecommunications device, such as a portable computer, for use in a WLAN (Wireless Local Area Network).

The multi-band antenna structure 1 according to the present invention is an integral structure, and can be stamped from a same metal sheet. Therefore, it is easy to assemble the multi-band antenna structure 1 in a telecommunications device in one single action.

The invention may be embodied in other specific forms without departing from its spirit or essential characteristics. The described embodiment is to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A multi-band antenna structure for use in a telecommunication device comprising:
a ground plane; and
a plurality of radiating elements comprising:
a first radiating element including a first radiating portion disposed beside the ground plane, and a first connecting portion connecting the first radiating portion with the ground plane;
a second radiating element including a second radiating portion disposed beside the first radiating portion, forming a first resonance slot therebetween, and a second connecting portion connecting the second radiating portion with the ground plane, wherein the second radiating portion further includes a feed-point for electrically connecting to a signal feed cable, the feed point being located adjacent to the second connecting portion;
a third radiating element including a third radiating portion disposed above the second radiating portion, and a third connecting portion connecting the third radiating portion with the second radiating portion;
a fourth radiating element including a fourth radiating portion disposed beside the third radiating portion, forming a second resonance slot therebetween, and a fourth connecting portion connecting the fourth radiating portion with the second radiating portion; and
a fifth radiating element including a fifth radiating portion disposed above the third radiating portion, forming a third resonance slot therebetween, and a fifth connecting portion connecting the fifth radiating portion with the second radiating portion.

2. The multi-band antenna structure of claim 1, wherein the first connecting portion and the second connecting portion both are located at a same side of the ground plane, and adjacent to each other.

3. The multi-band antenna structure of claim 2, wherein the third connecting portion, the fourth connecting portion, and the fifth connecting portion are all located at a same side of the second radiating portion, and adjacent to the feed-point.

4. The multi-band antenna structure of claim 1, wherein each of the radiating elements is substantially L-shaped.

5. The multi-band antenna structure of claim 4, wherein each of the radiating portions is much longer than each of the corresponding connecting portions.

6. The multi-band antenna structure of claim 1, wherein the ground plane and all of the radiating portions are respectively substantially elongated and rectangular.

7. The multi-band antenna structure of claim 6, wherein the ground plane and each of the radiating portions have parallel longitudinal axes.

8. The multi-band antenna structure of claim 1, wherein the ground plane and all of the radiating elements are stamped from a same metal sheet.

9. The multi-band antenna structure of claim 1, wherein a first length of the first resonance slot corresponds to a first resonance frequency.

10. The multi-band antenna structure of claim 1, wherein a second length of the second resonance slot corresponds to a second resonance frequency.

11. The multi-band antenna structure of claim 1, wherein a third length of the third resonance slot corresponds to a third resonance frequency.

12. The multi-band antenna structure of claim 9, wherein the first resonance frequency is substantially 2.45 GHz.

13. The multi-band antenna structure of claim 10, wherein the second resonance frequency is substantially 5.25 GHz.

14. The multi-band antenna structure of claim 11, wherein the third resonance frequency is substantially 5.7 GHz.

15. The multi-band antenna structure of claim 1, wherein the telecommunications device is a portable computer.

16. A multi-band antenna structure comprising:
a grounding plane defining a lengthwise direction thereof;
a first radiating element including a first connecting portion extending from one side of the grounding plane in a lateral direction perpendicular to said lengthwise direction, and a first radiating portion extending from said first connecting portion in the lengthwise direction;
a second radiating element extending from said side of the grounding plane and surrounding but spaced from said first radiating element, said second radiating element including a second connecting portion extending from said grounding plane in the lateral direction and defining a first plane, and a second radiating portion extending from said second connecting portion in the lengthwise direction and defining a second plane perpendicular to said first plane; and
a third radiating element coplanarly extending from said second radiating portion with a third radiating portion extending in said lengthwise direction and spaced from the second radiating portion.

17. The antenna structure of claim 16, further including a fourth radiating element substantially perpendicularly extending from said second radiating portion with a fourth radiating portion extending in said lengthwise direction and spaced from said second radiating portion.

18. The antenna structure of claim 16, further including another radiating element coplanarly extending from said second radiating portion and coplanarly spaced from said third radiating element.

19. The antenna structure of claim 16, wherein said third radiating element and said second radiating portion are substantially located by two sides of said first plane.

20. The antenna structure of claim 19, wherein said third radiating element results in a resonance slot between the first radiating portion and the second radiating portion in said first plane.

21. A multi-band antenna structure comprising:
a grounding plane defining a lengthwise direction thereof;
a first radiating element including a first connecting portion extending from one side of the grounding plane in a lateral direction perpendicular to said lengthwise direction, and a first radiating portion extending from said first connecting portion in the lengthwise direction;
a second radiating element extending from said side of the grounding plane and surrounding but spaced from said first radiating element,
said second radiating element including a second connecting portion extending from said grounding plane in the lateral direction and defining a first plane, and a second radiating portion extending from said second connecting portion in the lengthwise direction and defining a second plane perpendicular to said first plane; and
another radiating element perpendicularly extending from said second radiating portion away from the first radiating element, with another radiating portion extending in said lengthwise direction and spaced from the second radiating portion.

22. The structure of claim 21, wherein said another radiating element results in a resonance slot between said first radiating portion and said second radiant portion in said first plane.

23. A multi-band antenna structure comprising:
a grounding plane defining a lengthwise direction thereof;
a radiating element including a connecting portion extending from one side of the grounding plane in a lateral direction perpendicular to said lengthwise direction, and a radiating portion extending from said connecting portion in the lengthwise direction; and
at least two L-shaped radiating elements extending from one side of said radiating portion generally in a one-by-one overlapping manner; wherein
one of said at least two radiating elements define a first plane perpendicular to a second plane defined by the other thereof.

24. The structure of claim 23, wherein said first plane is perpendicular to said radiating portion.

25. The structure of claim 23, wherein said at least two L-shaped radiating elements further includes a third L-shaped radiating element which extends in said first plane and cooperates with said one to sandwich the other one therebetween.
